(19) United States
(12) Patent Application Publication
(10) Pub. No.: US 2023/0166332 A1
(43) Pub. Date: Jun. 1, 2023

(54) Optimising process parameters in additive manufacturing

(71) Applicants: National University of Singapore, Singapore (SG); The Regents of the University of California, Oakland, CA (US)

(72) Inventors: Lina YAN, Singapore (SG); Jerry Y.H. FUH, Singapore (SG); Chih-Ming HO, Oakland, CA (US); Jeffrey Huy KHONG, Oaklnad, CA (US)

(21) Appl. No.: 17/998,155

(22) PCT Filed: May 10, 2021
(86) PCT No.: PCT/SG2021/050256

§ 371 Date: Nov. 7, 2022

Related U.S. Application Data
(60) Provisional application No. 63/022,331, filed on May 8, 2020.

(51) Int. Cl. B22F 10/31; B33Y 50/00; B33Y 30/00; B22F 10/38; B22F 10/36; B22F 10/80; B29C 64/386

(52) U.S. Cl. CPC B22F 10/31; B33Y 50/00; B33Y 30/00; B22F 10/38; B22F 10/36; B22F 10/80; B29C 64/386; B22F 2203/00

(57) ABSTRACT

A method of determining optimal values of one or more process parameters for printing a part comprises obtaining a plurality of sets of test values for the one or more process parameters. An additive manufacturing system is caused to at least partially generate a plurality of test samples according to a design and the plurality of sets of test values. During or after generation of the plurality of test samples, test data indicative of respective measurements of at least one property of the test samples are obtained. The test data are fitted to a second-order function of the one or more process parameters to determine coefficients of the one or more process parameters. Based on the second-order function and the coefficients, optimal values are determined for the one or more process parameters that result in a global optimum for the at least one property.

### TECHNICAL FIELD

The present invention relates to a system and a method for optimising process parameters in additive manufacturing systems.

### BACKGROUND

In an Additive Manufacturing (AM) system, fabrication parameters and the magnitudes of the parameters determine the AM product performance. There are more than 100 parameters reported in the literature for AM systems, of which more than 10 parameters have been recommended as key parameters. The magnitudes of these parameters can be large, and a small variation in the magnitude of a parameter can cause significant differences in the resulting properties of manufactured parts. Since N magnitude levels for P parameters will form a search space of size N^{P}, the search-for-all approach can become a prohibitive task for optimising the AM parameter combinations. Thus, parameter optimisation can be increasingly challenging. In addition, all manufacturing processes are dynamic, and so optimisation of a N^{P} search space in the time domain was not possible in the past.

On the other hand, it is possible to study limited combinations of parameters in a small range, using either trial-and-error methodology or response surface methodology (RSM). However, those methods are not fully portable for different printers and materials. This is caused by the unsteady latency effect in the AM process. In a powder-based AM system, after melting or sintering of metal powders in a specific layer, or at a specific scanning point, the local temperature will drop from the melting temperature to the printer chamber temperature quickly. The microstructures of the specific layer, and also the previous layers, can be altered by the dynamic heat transfer rate. Therefore, the microstructure of parts from the AM process is a result of a latency effect in the manufacturing process.

Moreover, this fast solidification process will induce residual stress from a mismatch in the thermal expansion coefficient of the liquid melt pool and solidified parts. Again, the residual stress can be affected by the dynamic heat transfer rate. The residual stress occurs after the high temperature source being removed and hence is a latency issue. Furthermore, in heat-treatment of single metal or alloy parts, the distribution of the compositions and the microstructures depend on the cooling rate after the material is moved out of the furnace. Therefore, the efficiency of post-processing heat treatment of AM parts is related to latency. These latency effects in AM systems significantly affect the performance and yield of endpoint products, but that problem cannot be handled by process optimisation methodologies that are based only on the end-point product.

Accordingly, it is clear that there are several major roadblocks with respect to current AM parameter optimisation methods. For example, while it is possible to optimise AM parameters by using RSM, this is an optimisation method for the endpoint product only, and is limited in that it cannot dynamically optimise the process during manufacturing.

The trial-and-error method can only be used in steady case, for endpoint products, and requires a large number of experiments, and generally locates only sub-optimal conditions and thus results in a sub-optimal end product.

In addition, even using the same set of parameters, variations in the quality of the energy delivery system, the cooling system and the powder-delivery system from different equipment manufacturers can cause different melting and solidification rates. This may cause non-reproducibility of parts when using the same parameters on different printers.

Last but not least, product performance can depend strongly on raw materials, especially for the raw powders used in the AM system. It is common for the performance properties to change from one batch powder to another one. This is a major problem in industry for large-volume production. Raw material properties are not like operational parameters and cannot be controlled during the manufacturing process. The fact is that the optimal printing parameters shift when new powders were added, or even when the powders are recycled. Existing parameter optimisation methodology cannot address this problem.

It is desired to overcome or alleviate one or more of the above difficulties, or to at least provide a useful alternative.

### SUMMARY

The present disclosure relates to a method of determining optimal values of one or more process parameters for printing a part by additive manufacturing, the part having a design, the method comprising steps of:
(i) obtaining a plurality of sets of test values for the one or more process parameters;
(ii) causing an additive manufacturing system to at least partially generate a plurality of test samples according to the design and the plurality of sets of test values;
(iii) obtaining, during or after generation of the plurality of test samples, test data indicative of respective measurements of at least one property of the test samples for respective sets of test values;
(iv) fitting the test data to a second-order function that relates the at least one property to the one or more process parameters to determine coefficients of the one or more process parameters; and
(v) determining, based on the second-order function and the coefficients, optimal values for the one or more process parameters that result in a global optimum for the at least one property.

In some embodiments, the method is performed for a single batch of raw material. Accordingly, optimal parameters can be obtained on a per-batch basis prior to commencing a production run, thus accounting for inter-batch variability. Each time a new batch of raw material is obtained, the optimisation method may therefore be re-performed in order to obtain a new set of optimal process parameters for the new batch.

In some embodiments, step (ii) comprises partially generating one of the test samples, and step (iii) comprises obtaining test data for the partially generated test sample, such that the global optimum is obtained prior to completion of generation of the test sample.

In some embodiments, partially generating one of the test samples comprises printing one layer or a few layers of the test sample; and obtaining test data comprises measuring a temperature distribution of the partially generated test sample.

In some embodiments, the plurality of test samples are generated at different respective times.

In some embodiments, the at least one property comprises one or more of: porosity, residual stress, mechanical properties, surface properties, electronic or magnetic related properties.

In some embodiments, the mechanical properties comprise one or more of: yield stress and compressive stress; and/or wherein the surface properties comprise surface roughness.

In some embodiments, the at least one process parameter includes one or more of: laser power, scanning speed, powder-bed temperature, hatch distance, layer thickness, post processing heat treatment time, and temperature.

In some embodiments, the optimal values are determined using a 3D surface plot.

In some embodiments, the additive manufacturing system is powder based.

In some embodiments, the second-order function is: E (C,t)=x₀(cᵢ,t)+Σᵢ₌₁^{N}xᵢ(cᵢ,t)cᵢ+Σᵢ₌₁^{N}xᵢᵢ(cᵢᵢ,t)cᵢ²+Σᵢ₊₁^{N-1}Σⱼ₌ᵢ₊₁^{N}xᵢⱼ(cᵢⱼ,t)cᵢcⱼ; where E(C,t) is the at least one property, cᵢ, cᵢᵢ, and cᵢⱼ are the one or more parameters, and x₀, xᵢ, xᵢᵢ, and xᵢⱼ are the coefficients; and t is time.

In some embodiments, the plurality of sets of test values are obtained by orthogonal array composite design (OACD).

The present disclosure also relates to a system for optimisation of process parameters for printing a part by additive manufacturing, the part having a design, the system comprising:
at least one processor in communication with an additive manufacturing system; and
storage in communication with the at least one processor, the storage comprising instructions that, when executed by the at least one processor, cause the at least one processor:
obtain test data of samples at least partially generated by the additive manufacturing system in accordance with the design and a plurality of sets of test values of one or more process parameters, wherein the test data is indicative of respective measurements of at least one property of the test samples for respective sets of test values at one or more times during generation of the test samples;
fit the test data to a second-order function that relates the at least one property to the one or more process parameters to determine coefficients of the one or more process parameters; and
determine, based on the second-order function and the coefficients, optimal values for the one or more process parameters that result in a global optimum for the at least one property.

Some embodiments of the system further comprise the additive manufacturing system.

In some embodiments, the storage comprises instructions for causing the at least one processor to cause the additive manufacturing system to print the part according to the design and the optimal values for the one or more process parameters.

The present disclosure also relates to a method of printing a part by an additive manufacturing system, the part having a design, the method comprising: determining optimal values of one or more process parameters for an additive manufacturing system by a method as disclosed herein; and causing the additive manufacturing system to print the part according to the design using the optimal values of the process parameters.

The present disclosure further relates to non-transitory computer readable storage comprising computer-executable instructions for causing at least one processor to carry out the method as disclosed herein.

### BRIEF DESCRIPTION OF FIGURES

Embodiments of the present invention will now be described, by way of non-limiting example, with reference to the accompanying drawings in which:

FIG. 1 is a flow chart of an example method for optimisation of process parameters of an additive manufacturing process.

FIG. 2 shows example 3D surface plots and contour plots of yield stress as a function of three process parameters (laser power, scan speed, and temperature).

FIG. 3 is a block diagram of an example system for optimisation of process parameters for additive manufacturing.

### DETAILED DESCRIPTION

Some embodiments of the present invention are particularly applicable to optimisation of powder-based additive manufacturing processes, though not exclusively so. In powder-based additive manufacturing processes, high temperature always occurs during processing as the melting/sintering temperatures of powders are usually above 1000° C. Part density, thermal stress, mechanical properties such as yield strength, fracture strain and fatigue strength are functions of temperature and history of temperature variations, which are nonlinearly and dynamically dependent on multiple factors including but not limited to the following: instant temperature gradient, cooling rate, geometry of designed parts, thermal conductivity of finished parts and surrounding powder materials, and support structures.

Existing methods, such as the RSM method, cannot handle the latency effect in a dynamic AM process, since the coefficients change as a function of time and of the parameters themselves.

Accordingly, embodiments of the present invention relate to a method of determining optimal values of one or more process parameters for an additive manufacturing system, in which a plurality of test samples is generated by the additive manufacturing system in accordance with a plurality of sets of test values for the one or more process parameters. Test data indicative of one or more properties, such as surface roughness, yield stress, or other measures of quality of a printed part, are measured for each of the test samples. The test data are then fitted to a second order function of the one or more process parameters, to determine coefficients of the one or more process parameters. Finally, optimal values for the one or more process parameters are determined based on the coefficients and the second order function. The optimal values result in a global optimum for the at least one property.

In some embodiments, the second order function (also referred to herein as the parabolic response surface, PRS, function) is the following:

E(C,t)=x₀(cᵢ,t)+Σᵢ₌₁^{N}xᵢ(cᵢ,t)cᵢ+Σᵢ₌₁^{N}xᵢᵢ(cᵢᵢ,t)cᵢ²+Σᵢ₌₁^{N-1}Σⱼ₌ᵢ₊₁^{N}xᵢⱼ(cᵢⱼ,t)cᵢcⱼ (1)

Here, E is the property to be optimised, and cᵢ, cᵢᵢ, and cᵢⱼ are the one or more process parameters. As can be seen from Function (1), the coefficients x₀, xᵢ, xᵢᵢ and xᵢⱼ are each non-constant, in that in general, they depend on the values of the process parameters themselves, as well as time t. By incorporating such dependence, it is possible to account for latency effects, as well as complex interactions between the process parameters during the additive manufacturing process.

It will be appreciated that if more than one property is to be optimised, Function (1) may be modified accordingly, with the quantity E then being written as Eₖ, and coefficients x₀ as x₀ₖ, xᵢ as xᵢₖ, etc., with the index k running from 1 to the number of properties.

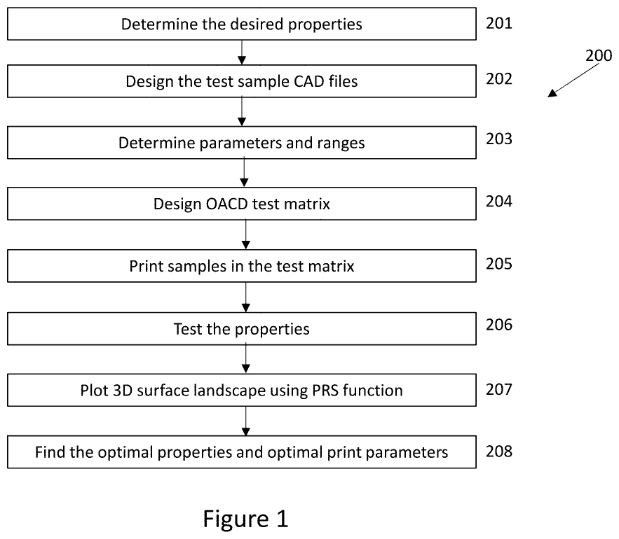

One example of a method 200 consistent with embodiments of the present invention will now be described with reference to FIG. 1. As shown in FIG. 1, a parameter optimisation method 200 may comprise first determining what properties need to be optimised (201). The properties can be any quantitatively measurable properties, e.g., porosity, mechanical properties, surface properties, electronic or magnetic related properties, etc.

Once the properties have been determined, a test sample CAD file may be designed according to ASTM/ISO or other application-based test designs (202). For example, tensile and compressive test samples can be designed according to ASTM E8 and E9. If a specific property is desired, the appropriate testing CAD file may be designed accordingly. The test designs may correspond to a design of a particular part that is to be printed by the additive manufacturing system.

Next, the parameters which may affect the properties based on the understanding of the process-microstructure-property relationships are determined (203). For example, it is generally known that the porosity and strength in the printed parts are strongly dependent on the laser power, scanning speed, powder-bed temperature, hatch distance, layer thickness, post processing heat treatment time and temperature, etc. Therefore, those key parameters can be candidate variables to obtain the desired porosity and strength.

An orthogonal array composite design (OACD) test printing matrix can then be designed based on the selection of parameters and their magnitudes (204). The OACD will provide the number of tests and the magnitudes of each parameter for each test combination.

Once the test samples according to the OACD matrix design have been at least partly printed (205), the properties to be optimised may be measured according to ASTM/ISO or other application-based designs using appropriate equipment (206).

For example, in one embodiment, all test samples may be fully printed (sequentially, or at substantially the same time) according to the design, in accordance with the respective sets of test parameters. One or more properties, such as yield stress or surface roughness, of the finished test samples can then be measured.

In another embodiment, one or more of the test samples may be partially printed according to the design, in accordance with the respective sets of test parameters. For example, one layer, or a few layers (e.g. 2, 3, 4, or 5, 6, 7, 8, 9, or 10 layers) may be printed at step 205. Then, at step 206, one or more properties of the partially printed test sample(s) may be measured by a non-destructive technique. For example, a temperature distribution of the respective partially printed test sample(s) may be indirectly determined using a camera, since the temperature distribution is related to the intensity (or brightness of the pixels) of the image of the melt pool. Based on the light intensity of the melt pool captured by the camera, the temperature can be calculated by methods known to the skilled addressee. In another example, X-rays, or acoustic or ultrasonic waves, may be used to measure one or more properties of the partially printed test sample(s), such as (by way of non-limiting example) porosity and residual stress.

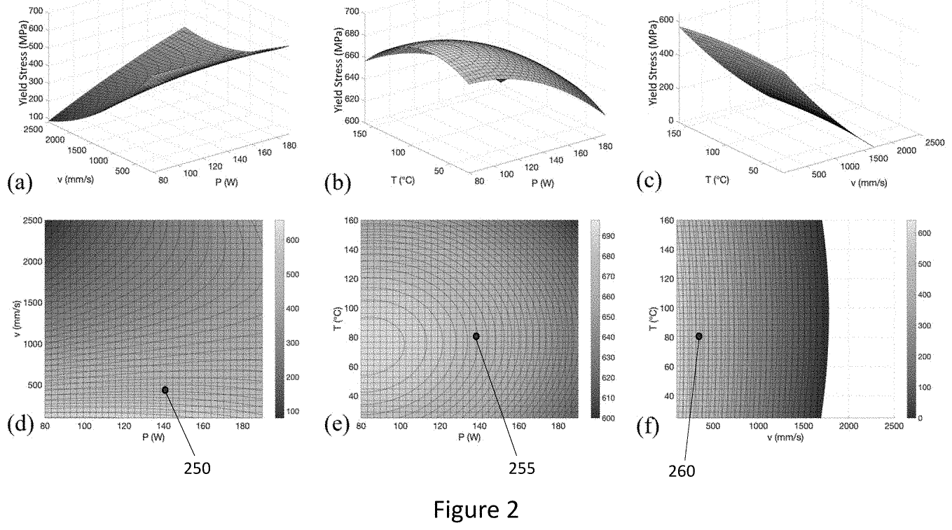

To determine the optimised parameters, the parabolic response surface (PRS) function on the right-hand side of Function (1) is fitted to the measured data to determine the coefficients of the PRS function. The 3D surface of each property may then be plotted using the PRS function (207), as shown for example in FIG. 2. This may be performed using commercially available analysis and plotting software such as, for example, Python, R, and MATLAB.

Once plotted, the optimal achievable properties and corresponding process parameters on the 3D landscape plot may be determined (208).

Once the optimal process parameters are determined, they may be used to print the desired part according to the design, using the additive manufacturing system.

In embodiments where the optimal parameters are determined after the test samples are fully printed, this may precede the printing of a large number of copies of the part. The parameter optimisation process is therefore “dynamic” in the sense that the optimal parameters of the additive manufacturing system may have changed since the previous printing run, for example for a different part or using a different batch of raw material. This may be desirable for industrial-scale manufacturing, since the parameter optimisation process may be carried out using only a small number of test samples (e.g. only 10 test samples for 3 process parameters), prior to printing large numbers of parts that will consume a large amount of material.

In embodiments where the optimal parameter values are determined during (rather than after) printing of a test sample, the process parameters used by the additive manufacturing system may be adjusted during printing of the part. In such embodiments, the parameter optimisation process can be considered dynamic because it can be conducted in real time, thus enabling the process parameters to be adjusted on the fly to optimise the final printed part, also avoiding failure of the print due to (for example) distortion caused by excessive thermal stress. This may be desirable for more specialised parts that are difficult to print, or are printed in small numbers or for specialised purposes.

In some embodiments, experimental data may be used to train the PRS function to determine the relationships between the one or more properties, and the corresponding process parameters. The optimal properties can then be calculated from the PRS function, and the corresponding optimal parameters can be located by reading off from the property-parameter surface plot. The optimal properties may include, but are not limited to, minimal surface roughness, highest yield strength, and best fatigue strength.

The number of calibration tests generated at step 204 depends on the number of process parameters, e.g., manufacturing parameters. In Table 1 below, a comparison of the minimum number of tests required for parameter optimisation using conventional Design of Experiments (DoE) methodology is compared with the present methodology, assuming P process parameters with each parameter having ten levels within its effective range.

TABLE 1
Comparison between conventional DoE
methodology with the present methodology:

| | # of tests using | # of tests |
|---|---|---|
| # of | conventional | (=coefficients) using |
| Parameters (P) | methods (N = 10) | OACD with function (1) |
| 1 | 10¹ | 3 |
| 2 | 10² | 6 |
| 3 | 10³ | 10 |
| 4 | 10⁴ | 15 |
| 5 | 10⁵ | 21 |
| 6 | 10⁶ | 28 |
| 7 | 10⁷ | 36 |
| 8 | 10⁸ | 45 |
| 9 | 10⁹ | 55 |
| 10 | 10¹⁰ | 66 |

It can be seen that orders of magnitude of effort, time and cost can be saved by applying Function (1). Conventional methods generally require a large number of tests to sample a P-dimensional space, before optimal parameters corresponding to the optimal outcomes may be chosen. On the other hand, only a small number of tests need to be used with embodiments of the present (PRS combined with OACD) method. The Orthogonal Array Composite Design (OACD) method strategically chooses test locations based on an approximate uniform sampling of values across the range of each parameter. These combinations allow for the determination of the quadratic effects of, and interaction effects between, each process parameter, and thus the best representation of PRS in a P-dimensional surface.

Once the test samples are printed and the properties to be optimised are measured, as mentioned above in relation to step 207, the PRS function (1) can be used to fit the resulting data. The PRS is a convoluted surface in a P-dimensional space. The resulting surface can be used to determine the optimal parameters and the optimal outcomes of the measured properties. For example, as shown in FIG. 2, the yield stress can be optimised by manipulating the power, printing speed, and temperature.

In FIG. 2, The R-squared value of the PRS surface with respect to the measured data was 0.925, showing that the experimental data supports the PRS method. The smooth PRS 3-D plots provides additional support for the fitting of the experimental data with the PRS method. The optimal parameters (V, P, and T) as well as the optimal outcome (maximum yield stress) can then be determined from the PRS 3-D plots (as shown at 250, 255, and 260 in FIG. 2). In addition, the PRS function (Function (1)) can be used to mathematically determine the optimal parameter for an optimised outcome by calculating the minimum value over the range of magnitudes for each parameter.

Several intermediate tests at different time points of each calibration test can be used for dynamical optimisation.

In an alternative embodiment, Function (1) can be written in an integral function form as shown below:

$${{\int }_{{T}_{0}}}^{T} E ( C , t ) dt = {{\int }_{{T}_{0}}}^{T} {x}_{0} ( t ) dt + {{\int }_{{T}_{0}}}^{T} {\sum }_{i = 1}^{N} {x}_{i} ( {c}_{i} , t ) {c}_{i} ( t ) dt + {{\int }_{{T}_{0}}}^{T} {\sum }_{i = 1}^{N} {x}_{i i} ( {c}_{i i} , t ) {c}_{i}^{2} ( t ) dt + {{\int }_{{T}_{0}}}^{T} {\sum }_{i = 1}^{N - 1} {\sum }_{j = i + 1}^{N} {x}_{ij} ( {c}_{ij} , t ) {c}_{i} ( t ) {c}_{j} ( t ) dt$$

In the above integral function form, (T−T₀) is the time increment of measuring the property to be optimised, where T should be long enough such that the change of that property is larger than the noise.

In the case of powder-based AM, laser power and scan speed are two independent process parameters. However, the melting/solidification speed and thermal stress depend on heat transfer rate, the governing function for which is boundary-condition dependent.

The number of coefficients in Function (1) for a P parameter combination is [1+(P²+3P)/2], which is orders of magnitude less than N^{P}. In other words, the present method only needs to perform [1+(P²+3P)/2] tests to solve the coefficients of Function (1) instead of search all cases in the N^{P} space. Hence, orders of magnitude of tests, time and cost can be saved. In addition, the implementation of the present method is independent of the underlying physical, chemical and biological mechanisms. Hence, it can also be applied to optimisation of AM fabrication parameters for any materials.

In this process, the non-constant coefficients of xᵢ(cᵢ,t), xᵢᵢ(cᵢᵢ,t), xᵢⱼ(cᵢⱼ,t) in Function (1) are functions of 1) melting pool features, 2) temperature gradient among melting pool, printing chamber, printed/solidified layers and powder-bed, 3) thermal conductivity of substrate, powders and printed layers, 4) geometry of solidified layers, 5) impurities levels in raw materials, 6) dynamic effects such as latency of the melting and solidification process.

System for Optimising Process Parameters

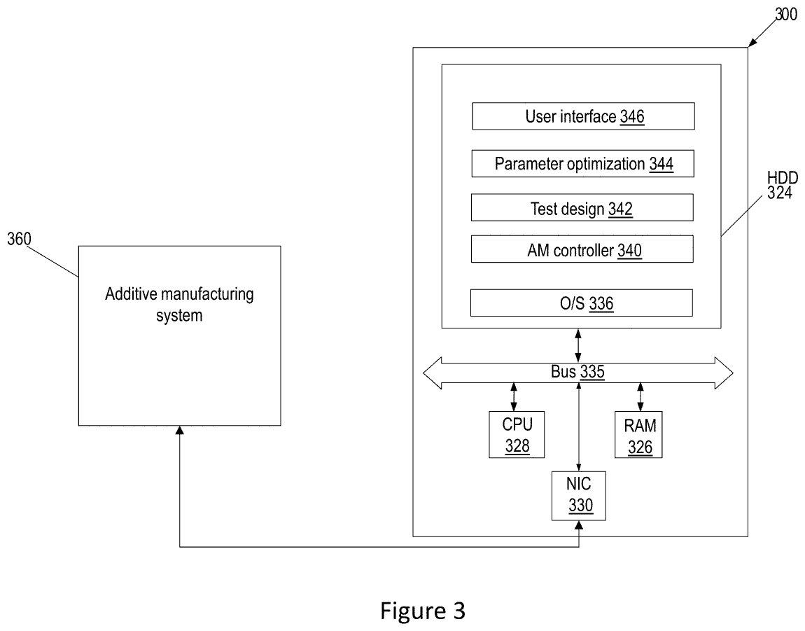

FIG. 3 shows an example architecture of a system 300 for optimising process parameters for additive manufacturing. The parameter optimisation system 300 is in communication with an additive manufacturing system 360. In some embodiments, the additive manufacturing system 360 may form part of the parameter optimisation system 300. The additive manufacturing system may be, for example, a powder bed fusion system.

The parameter optimisation system 300 may be implemented as one or more computing devices. The components of the computing device can be configured in a variety of ways. The components can be implemented entirely by software to be executed on standard computer server hardware, which may comprise one hardware unit or different computer hardware units distributed over various locations, which may communicate over a network. Some of the components or parts thereof may also be implemented by application specific integrated circuits (ASICs) or field programmable gate arrays.

In the example shown in FIG. 3, a computing device 300 is a commercially available server computer system based on a 32 bit or a 64 bit Intel architecture, and the processes and/or methods executed or performed by the computing device 300 are implemented in the form of programming instructions of one or more software components or modules 340, 342, 344, 346 stored on non-volatile (e.g., hard disk) computer-readable storage 324 associated with the computing device 300. At least parts of the software modules could alternatively be implemented as one or more dedicated hardware components, such as application-specific integrated circuits (ASICs) and/or field programmable gate arrays (FPGAs).

The computing device 300 includes at least one or more of the following standard, commercially available, computer components, all interconnected by a bus 335: random access memory (RAM) 326; at least one computer processor 328, and a network interface connector (NIC) 330 which connects the computer device 300 to a data communications network and/or to external devices, such as additive manufacturing system 360.

The computing device 300 includes a plurality of standard software modules, including an operating system (OS) 336 (e.g., Linux or Microsoft Windows). The standard software modules may also include standard mathematical modelling or statistical software such as R or MATLAB.

The computing device 300 may also include several further software modules or components having specific functions.

For example, computing device 300 may include an additive manufacturing (AM) controller 340 that is configured to send control signals to additive manufacturing system 360 to cause it to print one or more parts in accordance with a part design. The part design may be encoded in a suitable file format, such as an STL file, which may be generated by the system 300 or may be a previously generated and stored file that is retrieved from storage (such as storage 324) for transmission to the additive manufacturing system 360, together with values of one or more process parameters, to cause it to print the one or more parts in accordance with the design and the one or more process parameters.

Computing device 300 may also include a test design component 342. The test design component 342 may implement an OACD process to generate a plurality of sets of test values of one or more process parameters (such as the sets of values shown in Table 1). In some embodiments, the test design component 342 may also enable user input regarding the design of the part to be printed. For example, the user may be provided with means to upload a design file (e.g. in STL format), and/or to manually adjust the design (e.g., the design of the part and/or of the support structure for the part).

The computer system 300 may further include a parameter optimisation component 344. The parameter optimisation component 344 may be configured to receive test data of samples created by the additive manufacturing system 360 in accordance with the plurality of sets of test values of the one or more process parameters (e.g. as generated by test design component 342), wherein the test data is indicative of respective measurements of at least one property of the test samples for respective sets of test values. The test data may be received by a user uploading measurements for the one or more parameters, or may be automatically obtained from testing equipment (not shown) that is in communication with computer system 300 over network interface 330. Further, the parameter optimisation component 344 may be configured to fit the test data to a second-order function that relates at least one property of the test samples (e.g. surface roughness, yield stress, and/or compressive stress) to the one or more process parameters to determine coefficients of the one or more process parameters. The parameter optimisation component 344 may also be configured to determine, based on the PRS function, optimal values for the one or more process parameters that result in a global optimum for the at least one property.

The computer system 300 may also include a user interface component 346 that generally enables the computer system 300 to receive input from a user, such as input in relation to design of the part to be printed. The user interface component 346 may be configured to receive data from the parameter optimisation component 344, and to display results to the user, for example the optimal values of the process parameters that optimise the at least one property of the printed part, and/or one or more 3D surface plots and/or contour plots of the at least one property as a function of two of the parameters (such as shown in FIG. 2).

The boundaries between the modules and components in the software modules 340-346 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the process 200 may be executed by a module (of software modules 340-346) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computing device 300 normally processes information according to a program (a list of internally stored instructions such as a particular application program and/or an operating system) and produces resultant output information, e.g. via user interface component 346. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Example

A set of test samples was printed using an EoS M290 SLM system (EoS, Germany). The samples were printed in accordance with the power, laser scan speed, and powder bed temperature values in Table 2 below, where the parameters were obtained using OACD. Table 2 shows the compression yield stress measured for the test samples G1-G16 according to ASTM E9 using an Instron 8848 (Instron, USA). Note that four of the test samples had distortion and could not be used for analysis. In embodiments of the present disclosure, where process parameters are adjusted according to their optimum values during printing, thermally distorted specimens can be avoided.

TABLE 2

| | | | | Compression |
|---|---|---|---|---|
| | P | v | T | Yield stress |
| OACD | (W) | (mm/s) | (° C.) | (MPa) |
| G1 | 190 | 2000 | 160 | 437.1 |
| G2 | 80 | 2000 | 160 | 220.1 |
| G3 | 190 | 400 | 160 | — |
| G4 | 80 | 400 | 160 | 534.2 |
| G5 | 190 | 2000 | 25 | 413.1 |
| G6 | 80 | 2000 | 25 | — |
| G7 | 190 | 400 | 25 | — |
| G8 | 80 | 400 | 25 | 534.1 |
| G9 | 80 | 1400 | 70 | 243.1 |
| G10 | 120 | 800 | 70 | 554.3 |
| G11 | 160 | 400 | 115 | — |
| G12 | 120 | 1400 | 160 | 302.6 |
| G13 | 120 | 1400 | 25 | 361.3 |
| G14 | 160 | 1400 | 115 | 474 |
| G15 | 160 | 900 | 25 | 446.2 |
| G16 | 120 | 2000 | 70 | 249.6 |

It can be seen that with three manufacturing parameters, P, V and T, 10 combinations based on the present technology, instead of 10³=1000 combinations, are needed to optimise the maximum yield stress.

Based on the measured compression yield stress, the PRS function (1) gives the maximum yield stress of 628 MPa, which is at the high end of all the data reported in the literature. The optimal manufacturing parameter-level combinations are 110 W, 200 mm/s and 80° C.

The G10 specimen had the measured highest yield stress, 554.3 Mpa. The processing parameters are 120 W, 800 mm/s and 70° C.

Embodiments of the present method and system provide one or more of the following advantages:
1. The number of searching experimental runs for printing parameter optimisation in powder-based AM system is significantly reduced.
2. The number of searching experimental runs for parameter optimisation in post-processing heat treatment of parts from powder-based AM is significantly reduced.
3. Using the platform to handle the latency effect, the post printing heat treatment can be integrated with the printing process.
4. The platform can be applied for parameter optimisation using powder-based AM technology for all types of materials, including but not limited to metals, polymers, ceramics, semi-conductors, metallic glass, thermal-electric materials, etc.
5. The platform can be applied for parameter optimisation using powder-based AM technology, for printing scales from micrometer to meters.
6. The platform can be applied for parameter optimisation using powder-based AM technology, for any of the properties that can be quantitatively measured or defined.
7. The platform can be applied for parameter optimisation for all types of powder-based AM technologies, regardless of the differences in the equipment and applications.
8. The platform not only can optimise but also can monitor the printing parameters in the powder-based AM system, therefore to enable us fabricate parts having predictable and customisable performance.
9. Using Function (1), performances of parts can be customised using different parameters in different layers/regions within one printing job.
10. Using the platform, performances of parts can be customised if two or more materials are printed or joined together via powder-based AM technology.
11. By optimising the process parameters using the platform, the thermal stress can be minimised with respect to the changing 3D geometrical features of part with increasing layers.
12. Mechanical properties, surface properties as well as geometrical features of complex parts having lattice structures and thin features can be optimised and even customised using different printing parameters at different layers or regions on one printing job.
13. Using the platform, printing parameters for each batch of new powders having different impurity levels can be optimised with a small number of tests.
14. Using the platform, printing parameters for each batch of reused, recycled, or mixed powders having different impurity levels, different shape and size distributions, different morphology as well as different chemical properties, can be optimised with a small number of tests.
15. Non-constant coefficients used in the platform can handle the latency problem associated with dynamic impurities diffusion or precipitation phase formation problem in the AM system.

Throughout this specification and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of determining optimal values of one or more process parameters for printing a part by additive manufacturing, the part having a design, the method comprising:
(i) obtaining a plurality of sets of test values for the one or more process parameters;
(ii) causing an additive manufacturing system to at least partially generate a plurality of test samples according to the design and the plurality of sets of test values;
(iii) obtaining, during or after generation of the plurality of test samples, test data indicative of respective measurements of at least one property of the test samples for respective sets of test values;
(iv) fitting the test data to a second-order function that relates the at least one property to the one or more process parameters to determine coefficients of the one or more process parameters; and
(v) determining, based on the second-order function and the coefficients, optimal values for the one or more process parameters that result in a global optimum for the at least one property.

2. A method according to claim 1, wherein the method is performed for a single batch of raw material.

3. A method according to claim 1, wherein step (ii) comprises partially generating one of the test samples, and step (iii) comprises obtaining test data for the partially generated test sample, such that the global optimum is obtained prior to completion of generation of the test sample.

4. A method according to claim 3, wherein partially generating one of the test samples comprises printing one layer or a few layers of the test sample; and obtaining test data comprises measuring a temperature distribution of the partially generated test sample.

5. The method of claim 1, wherein the plurality of test samples are generated at different respective times.

6. The method of claim 1, wherein the at least one property comprises one or more of: porosity, residual stress, mechanical properties, surface properties, electronic or magnetic related properties.

7. The method of claim 6, wherein the mechanical properties comprise one or more of: yield stress and compressive stress; and/or wherein the surface properties comprise surface roughness.

8. The method of claim 1, wherein the at least one process parameter includes one or more of: laser power, scanning speed, powder-bed temperature, hatch distance, layer thickness, post processing heat treatment time, and temperature.

9. The method of claim 1, wherein the optimal values are determined using a 3D surface plot.

10. The method of claim 1, wherein the additive manufacturing system is powder based.

11. The method of claim 1, wherein the second-order function is:
E(C,t)=x₀(cᵢ,t)+Σᵢ₌₁^{N}xᵢ(cᵢ,t)cᵢ+Σᵢ₌₁^{N}xᵢ(cᵢ,t)cᵢ+Σᵢ₌₁^{N}xᵢᵢ(cᵢᵢ,t)cᵢ²+Σᵢ₌₁^{N-1}Σⱼ₌ᵢ₊₁^{N}xᵢⱼ(cᵢⱼ,t)cᵢcⱼ;
where E(C,t) is the at least one property, cᵢ, cᵢᵢ, and cᵢⱼ are the one or more parameters, and x₀, xᵢ, xᵢᵢ, and xᵢⱼ are the coefficients; and t is time.

12. The method of claim 1, wherein the plurality of sets of test values are obtained by orthogonal array composite design (OACD).

13. A system for optimisation of process parameters for printing a part by additive manufacturing, the part having a design, the system comprising:
at least one processor in communication with an additive manufacturing system; and
storage in communication with the at least one processor, the storage comprising instructions that, when executed by the at least one processor, cause the at least one processor to:
obtain test data of samples at least partially generated by the additive manufacturing system in accordance with the design and a plurality of sets of test values of one or more process parameters, wherein the test data is indicative of respective measurements of at least one property of the test samples for respective sets of test values at one or more times during generation of the test samples;
fit the test data to a second-order function that relates the at least one property to the one or more process parameters to determine coefficients of the one or more process parameters; and
determine, based on the second-order function and the coefficients, optimal values for the one or more process parameters that result in a global optimum for the at least one property.

14. A system according to claim 13, further comprising the additive manufacturing system.

15. A system according to claim 13, wherein the storage comprises instructions for causing the at least one processor to cause the additive manufacturing system to print the part according to the design and the optimal values for the one or more process parameters.

16. A method of printing a part by an additive manufacturing system, the part having a design, the method comprising:
determining optimal values of one or more process parameters for the additive manufacturing system by a method according to claim 1; and
causing the additive manufacturing system to print the part according to the design using the optimal values of the process parameters.

17. Non-transitory computer readable storage comprising computer-executable instructions for causing at least one processor to carry out the method according to claim 1.
